(19) United States
(12) Patent Application Publication
(10) Pub. No.: US 2013/0134317 A1
(43) Pub. Date: May 30, 2013

(54) DETECTOR AND METHOD FOR DETECTING IONIZING RADIATION

(71) Applicant: Albert-Ludwigs-Universitaet Freiburg, Freiburg (DE)

(72) Inventors: Alex FAULER, Freiburg (DE); Christian DISCH, Sexau (DE); Andreas ZWERGER, Freiburg (DE); Markus DAMBACHER, Freiburg (DE); Michael FIEDERLE, Freiburg (DE)

(73) Assignee: ALBERT-LUDWIGS-UNIVERSITAET FREIBURG, Freiburg (DE)

(21) Appl. No.: 13/684,285

(22) Filed: Nov. 23, 2012

(30) Foreign Application Priority Data
Nov. 25, 2011 (DE) 10 2011 119 325.5

(51) Int. Cl. G01T 7/00

(52) U.S. Cl. CPC G01T 7/00
USPC 250/371; 250/370.01

(57) ABSTRACT

A detector and a method for the detection of ionising radiation are proposed. The detector (1) exhibits a detector body (2) made from a semiconductor material in which incident ionising radiation generates free electron-hole pairs, a cathode side (4) of the detector body (2) to which the free holes generated drift in an electric field, an anode side (3) of the detector body (2) to which the free electrons generated drift in an electric field, at least two electrodes (5, 6) on the anode side (3) and at least two electrodes (7, 8) on the cathode side (4). There is a potential difference between the electrodes (5, 6, 7, 8). The potential difference between the individual electrodes (7, 8) on the cathode side (4) is smaller than the potential difference between each of the electrodes (5, 6) on the anode side (3) on the one hand and each of the electrodes (7, 8) on the cathode side (4) on the other hand. As a result of irradiation of the detector body (2) with ionising radiation, electron-hole pairs are generated in the detector body (2). Signals are detected at the electrodes (7, 8) on the cathode side. The difference is calculated and evaluated from these signals.

The invention derives from a detector for the detection of ionising radiation and a method for the detection of ionising radiation.

Known detectors for the detection of ionising radiation exhibit a detector body made from a semiconductor material in which incident ionising radiation generates electron-hole pairs. The ionising radiation may for example be high-energy gamma radiation of several hundred keV. The detector body is equipped with electrodes on two opposite sides, which are referred to below as the anode side and the cathode side. The electrodes on the anode side and the cathode side have different electrical potentials. In the electric field in the detector body, the electrons of the electron-hole pairs formed by the ionising radiation migrate to the anode side, and the holes to the cathode side. The number of electron-hole pairs generated by the ionising radiation is in direct proportion to the energy of the ionising radiation. Suitable detectors have for example a detector body volume of several hundred mm³. A typical detector body is for example a cube with an edge length of around 1 cm.

In order to determine the energy of the ionising radiation as precisely as possible, the aim is to detect all electrons of the electron-hole pairs that have been formed by the radiation in the detector body. However this is often made more difficult by the fact that both electrons and holes can be caught at traps or can recombine with the other charge carrier type. This effect is described with the aid of the charge carriers' lifetime. Charge carriers can moreover be trapped at defects such as inclusions, twins, precipitates and similar in the detector body. This effect is dependent not on time, but on the distance traveled in the detector body. Compton scattering may furthermore occur, equally influencing the charge carriers detected.

The electrodes on the anode and cathode side are connected to one or more voltage sources via circuits in order to generate and maintain a potential difference between the electrodes. If electron-hole pairs are generated by the ionising radiation in the detector body, and if these electrons and holes in the detector body drift towards the electrodes, energy to move the charge carriers is given off by the electric field. To replace this energy in the electric field and maintain the application of a constant voltage potential at the electrodes, a capacitor is provided in the circuit, from which charge flows to the electrodes on the anode side and/or the cathode side. This capacitor is part of a charge-sensitive pre-amplifier. The capacitor is described as a feedback capacitor and its capacity as the feedback capacity C_{fb}. The charge flowing from the feedback capacitor to the detector's electrodes results in a change in the potential difference at the feedback capacitor. The progress in time of the possibly amplified change in the potential difference at the feedback capacitor forms the detector's signal. The progress in time of the possibly amplified change in the potential difference at the feedback capacitor is described below as the signal. The process of influencing the charge at the electrodes takes place during the movement of the electrons and holes inside the detector body and is completed when the charge carriers reach the electrodes. The change in potential difference at the feedback capacitor at the end of the charge carrier drift, discounting losses, is in direct proportion to the number of electron-hole pairs generated by the ionising radiation.

To overcome the problem of incomplete charge collection, there are various known approaches. In the charge loss correction method, on a detector with a planar electrode on the anode side and a planar electrode on the cathode side a signal is recorded on the anode side for which both the pulse height and the leading edge are evaluated. The extent of interaction is determined from this and a corresponding correction value calculated. It is furthermore known how to use optimised electrode and detector geometries to reduce the influence of the charge carriers' drift on the charge influenced on the anode side. This is done for example by only influencing the bulk of the electrons at the anode once the electrons are in the immediate vicinity of the anode side. This is achieved for example by two partially meshed electrodes in a coplanar arrangement on the anode side. Such an electrode structure is known for example from U.S. Pat. No. 5,530,249 A. It is referred to as a coplanar grid, or CPG for short. This designation is based on a Frisch grid, which is used in gas detectors. The function of the electrodes forming a coplanar grid on the anode side of a semiconductor detector is comparable to a Frisch grid in gas detectors. A coplanar grid has a planar electrode arranged on the cathode side and at least two electrodes with several strip-shaped sections on the anode side. These strip-shaped sections mesh and extend in an alternating electrode structure essentially along the entire anode side. The structure is also referred to as an interdigital structure. The electrode on the cathode side has a high negative potential compared with the electrodes on the anode side. By comparison, the potential difference between the electrodes on the anode side is significantly smaller. The electrode on the anode side with the greater potential difference compared with the electrode on the cathode side is referred to as a collecting electrode. The electrode on the anode side with the smaller potential difference compared with the electrode on the cathode side is referred to as a non-collecting electrode. The difference is calculated from the signals for the collecting electrode and the non-collecting electrode on the anode side. This difference represents the actual measurement signal. The advantage of such detectors is that the movement of the holes through virtually the entire detector body does not contribute to the profile of the actual measurement signal. The difference from the signal of the collecting electrode and the non-collecting electrode is generally regarded as information on only one charge carrier type, the electrons. The information obtained from the difference between the two signals concerns only a relatively small area of the detector body close to the anode side. Only in that area do the signals for the collecting and non-collecting electrode differ. The depth of that area is approximately the same size as the lateral spacing of the individual sections of the two electrodes on the anode side. By virtue of that relation, the method carried out using such detectors is also referred to as close-range measurement.

Although the detectors and methods known from prior art can reduce the problem of incomplete charge collection, they cannot eliminate it entirely. It is therefore the task of the present invention to supply a detector for and a method of detecting ionising radiation which further improve charge collection in order to determine as accurately as possible the number of charge carriers in the electron-hole pairs generated by the ionising radiation.

This task is solved by a detector having the features of claim 1 and by a method having the features of claim 9. The detector is characterised in that there are at least two electrodes arranged not just on the anode side, but also on the cathode side. The electrodes on the cathode side exhibit several preferably elongated sections. Elongated means that their length is large in comparison to their width and thickness. For this purpose the length and width are measured parallel to the surface of the cathode side, and the thickness perpendicular to the surface of the cathode side. The sections of the first and second electrode are adjacent on the surface of the cathode side, arranged a distance apart, and alternating. Adjacent refers to a direction parallel to the surface of the cathode side. In each case one section of the first electrode is arranged adjacent to at least one section of the second electrode. In each case one section of the second electrode is arranged adjacent to at least one section of the first electrode. Along the surface of the cathode side the sections form an alternating electrode structure which is also referred to as an interdigital structure. They essentially extend over the entire cathode end. The potential difference between the electrodes on the cathode side is small compared with the potential difference between each of the electrodes on the anode side on the one hand and each of the electrodes on the cathode side on the other hand. This results in a hole of an electron-hole pair formed by the ionising radiation in the detector body experiencing the same influence at some distance from the cathode side as in the case of a continuous planar electrode on the cathode side. Only when the hole migrates through the electric field near the cathode side does it experience a difference between the first electrode with the greater potential difference to the anode side and the second electrode with the smaller potential difference to the anode side. Under this influence, the hole moves towards the first electrode with the greater potential difference. This first electrode is referred to as the collecting electrode on the cathode side. The second electrode with the smaller potential difference compared with the anode side is referred to as the non-collecting electrode of the cathode side.

Based on the method according to the invention with the features of claim 9, both the signal for the first electrode on the cathode side and the signal for the second electrode on the cathode side are recorded. As explained earlier, each of these signals corresponds to the progress in time of the change in the potential difference of the feedback capacity of the detector's corresponding charge-sensitive pre-amplifier. There is a separate charge-sensitive pre-amplifier for each electrode on the cathode side. The difference is calculated from both signals. The signals for the first and second electrode differ only for the area near the cathode side. By calculating the difference between the two signals, information about this close range in particular is obtained.

As the holes in the semiconductor material of the detector body exhibit less mobility than the electrons, the transit times of the holes from the location of electron-hole pair formation in the detector body to the cathode side are longer than the transit times of the electrons from the location of electron-hole pair formation to the anode side. Electron-hole pairs that are formed in the immediate vicinity of the cathode side are of course an exception. The transit time of the holes can thus be determined from the difference between the signal for the first electrode on the cathode side and the signal for the second electrode on the cathode side. This transit time corresponds to the time that a hole needs to move from the position of electron-hole pair formation under incident ionising radiation to the cathode side. The start time can be calculated from the signal for any individual electrode on the detector. A clock can be started as soon as the signal for one of the electrodes exceeds a defined threshold. Due to the greater mobility of the electrons, it can for example be obtained from a signal for the electrodes on the anode side. It is assumed here that the transit time of the electrons is negligibly small compared with the transit time of the holes. Furthermore, the arrival of the electrons of the electron-hole pairs formed at the anode side can also be identified in the signal for the electrodes on the cathode side.

Because the transit time of the holes from the location of their formation until they reach the cathode side is much greater than the transit time of the electrons from the location of their formation until they reach the anode side because of their lower mobility, the transit time of the holes can be determined much more precisely from the signal for the electrodes on the cathode side than the transit time of the electrons from the signal for the electrodes on the anode side. It is immaterial here how great the losses of the holes released upon electron-hole pair formation are until they reach the cathode side. A qualitative rise in the differential signal for the electrodes on the cathode side is sufficient to determine the transit time of the holes.

If Compton scattering occurs in the incident ionising radiation in the detector body, electron-hole pairs are formed at various positions inside the detector body. These positions are numbered with i, where i runs from 1 to n and n is the total number of all positions at which electron-hole pairs are generated. The electron-hole pairs formed at an i^{th} position are hereinafter referred to as the i^{th} electron-hole pair cloud. The holes that are closest to the cathode reach the cathode side first. Depending on their location of formation in the detector body, the holes of the various electron-hole pair clouds reach the cathode side at different times. This is evident both from the signals for the two electrodes on the cathode side and from the difference formed from the signals.

From the transit time of the holes between the location of electron-hole pair formation and the cathode side, the position of electron-hole pair formation can be determined in terms of this position's distance from the cathode side. Because the distance between the cathode side and the anode side of the detector is known, this in turn indicates the distance of this position from the anode side. This information can be used to correct the signal for the electrodes on the anode side.

The results obtained from the signals for the two electrodes on the cathode side can be used to correct the signal for the electrodes on the anode side and to compensate largely for the incomplete charge collection.

According to an advantageous embodiment of the invention, the electrodes on the cathode side are in a coplanar arrangement. They are consequently in the same plane. In addition, one of the two electrodes may be arranged on an additional layer.

According to a further advantageous embodiment of the invention, at least some of the sections of the first electrode on the cathode side take the form of strips. Furthermore, at least some of the sections of the second electrode on the cathode side take the form of strips. The strips may exhibit a rectilinear or curved shape. The strip-shaped sections of the first and second electrodes alternate, with the result that a first section is arranged between two second sections and a second section is arranged between two first sections. The sections at the edge of the cathode side are an exception.

According to a further advantageous embodiment of the invention, the strips exhibit a rectilinear shape and are parallel with each other.

According to a further advantageous embodiment of the invention, the strips exhibit a curved shape around a common centre. They may for example form sections of circles that are arranged around a common centre of a circle.

According to a further advantageous embodiment of the invention, the electrodes on the anode side form a two-dimensional pixel array. This electrode structure supplies spatially resolved information on the location of formation of the electron-hole pairs in the detector volume.

According to a further advantageous embodiment of the invention, the electrodes on the anode side form a coplanar grid. To that end, for example a first electrode and a second electrode on the anode side exhibit several sections that mesh in a comb shape.

According to a further advantageous embodiment of the method according to the invention, on a detector according to the invention with a collecting and a non-collecting electrode on the anode side forming a coplanar grid, the total charge Q_{e,m}^{total} of the electrons arriving at the anode side from the electron-hole pairs formed by the incident radiation is determined from the difference between the signal for the collecting electrode and the non-collecting electrode. In addition, the charge Q_{h,m}ⁱ of the holes of the i^{th} electron-hole pair cloud and the transit time tₕⁱ of the holes of the i^{th} electron-hole pair cloud are determined from the difference between the signals for the first and second electrode on the cathode side. The total charge Q_{e,d}^{total} of all electrons of the electron-hole pairs formed by the incident radiation is calculated from the product of Q_{e,m}^{total} and the factor k. Here, k depends on the total of all Q_{h,m}ⁱ, the transit times tₕⁱ of the holes, the mobility of the electrons and holes in the detector body, the potential difference between the electrodes and the distance between the anode side and the cathode side.

According to a further advantageous embodiment of the method according to the invention, k is calculated with

1/k=ΣQ_{h,d}ⁱ/Q_{h,d}^{total}*gₑ(tₑⁱ)

where Q_{h,d}ⁱ is the charge of all holes of the i^{th} electron-hole pair cloud formed by the radiation, Q_{h,d}^{total} is the total charge of all holes of the electron-hole pairs formed by the incident radiation and tₑⁱ is the transit time of the electrons of the i^{th} electron-hole pair cloud. gₑ(tₑⁱ) is determined by calibration measurements at the detector or can in the first approximation be assumed to be gₑ(tₑⁱ)=exp(−tₑⁱ/Tₑ), where Tₑ represents the electron lifetime to be determined experimentally. The following applies:

$${Q}_{e , d}^{i} = {f}_{e} ( {t}_{e}^{i} ) \cdot {Q}_{e , m}^{i} = \text{:} \frac{1}{{g}_{e} ( {t}_{e}^{i} )} \cdot {Q}_{e , m}^{i}$$

$${Q}_{h , d}^{i} = {f}_{h} ( {t}_{h}^{i} ) \cdot {Q}_{h , m}^{i}$$

Here the footnotes e stand for electrons, h for holes, d for deposited and m for measured. Q_{e,d}ⁱ is the charge of the electrons in the i^{th} electron-hole pair cloud that is generated by the energy of the ionising radiation deposited in the detector body. Q_{e,m}ⁱ is the charge of the electrons in the i^{th} electron-hole pair cloud that is detected on the anode side. fₑ(tₑⁱ) is a function that describes the incomplete charge collection of the electrons as a function of the transit time of the electrons in the i^{th} electron-hole pair cloud. Qh_{,d}ⁱ is the charge of the holes in the i^{th} electron-hole pair cloud that is generated by the energy of the ionising radiation deposited in the detector body. Qh_{,m}ⁱ is the charge of the holes in the i^{th} electron-hole pair cloud that is detected on the cathode side. fₕ(tₕᵢ) is a function that describes the incomplete charge collection of the holes as a function of the transit time of the holes in the electron-hole pair cloud. fₑ(tₑⁱ) and fₕ(tₕⁱ) can be determined by calibration measurements at the detector.

The transit times of the electrons in the individual electron-hole pair clouds can be determined from the transit times of the holes according to:

$${t}_{e}^{i} = ( {t}_{h}^{max} - {t}_{h}^{i} ) \cdot \frac{{μ}_{h}}{{μ}_{e}}$$

where tₕ^{max} is the maximum transit time of the holes for a given detector geometry and bias voltage. It corresponds to the transit time of a hole from the anode side to the cathode side. μₑ is the mobility of the electrons in the detector body. It can be determined by calibration measurements at the detector. μₕ is the mobility of the holes in the detector body. It can be determined by calibration measurements at the detector.

Then:

$$\begin{matrix}{Q}_{e , m}^{total} = {\sum }_{i} {Q}_{e , m}^{i} \\ = {\sum }_{i} {g}_{e} ( {t}_{e}^{i} ) \cdot {Q}_{e , d}^{i} = \\ = {Q}_{e , d}^{total} \cdot {\sum }_{i} \frac{{Q}_{e , d}^{i}}{{Q}_{e , d}^{total}} \cdot {g}_{e} ( {t}_{e}^{i} ) = \\ = {Q}_{e , d}^{total} \cdot {\sum }_{i} \frac{{Q}_{h , d}^{i}}{{Q}_{h , d}^{total}} \cdot {g}_{e} ( {t}_{e}^{i} ) ⇒\end{matrix} \\ ⇒ {Q}_{e , d}^{total} = k \cdot {Q}_{e , m}^{total}$$

$$with \frac{1}{k} = {\sum }_{i} \frac{{Q}_{h , d}^{i}}{{Q}_{h , d}^{total}} \cdot {g}_{e} ( {t}_{e}^{i} )$$

This follows from

$$\frac{{Q}_{e , d}^{i}}{{Q}_{e , d}^{total}} = \frac{{Q}_{h , d}^{i}}{{Q}_{h , d}^{total}} ∀ i$$

because the distribution of the energy deposition for any interaction is always the same for electrons and holes since they are always generated in pairs.

The value of the charge for electrons measured on the anode side can be corrected with the factor k. k itself contains only directly measurable quantities along with functions f and g that can be determined phenomenologically or from the above theories. The temporal dependence of the functions f and g here can also be expressed by different times to tₑ and tₕ, for example by the difference Δtₕ=tₕ−tₑ, or determined phenomenologically. The dependence t′ here must be chosen in such a way that there is a bijective relationship between t′ and the depth of interaction, in other words the actual transit times or drift times tₑ and tₕ.

According to a further advantageous embodiment of the invention, the following process steps are carried out to detect ionising radiation:
1. A clock is started using the signal for one of the electrodes of the detector or from the sum of or difference between the signals for two electrodes when a threshold is exceeded. The clock is preferably started using the sum of the signals for the collecting electrode and the non-collecting electrode on the anode side, as that signal rises the most steeply. The following steps are carried out until time tₕ^{max} is reached. This corresponds to the time that a hole needs to migrate from the anode side to the cathode side. Up until that point in time resetting the clock to zero, also referred to as a renewed timer start, is not permitted.
2. Determination of Q_{e,m}^{total} from the subtracted signal for the collecting electrode and the non-collecting electrode on the anode side. This takes place in accordance with the coplanar grid electronics known from U.S. Pat. No. 5,530,249 A.
3. Determination of pulse heights Q_{h,m}ⁱ and transit times tₕⁱ of the holes of the i^{th} electron-hole pair clouds from the time of starting the clock:
   a. Each time the holes strike the cathode side, the deposited energy Q_{h,d}ⁱ can be calculated immediately by means of a known table for the detector: Q_{h,d}ⁱ=cⁱ·Q_{h,m}ⁱ. The following applies for the correction factors stated in the table: cⁱ=fₕ(tₕⁱ) where tₕⁱ determines the address within the table.
   b. Updating or storing of the sum

$${Q}_{h , d}^{total} = {\sum }_{i} {Q}_{h , d}^{i}$$

after every incident.
c. Calculation of the transit times of the electrons from the transit times of the holes

$${t}_{e}^{i} = ( {t}_{h}^{max} - {t}_{h}^{i} ) \cdot \frac{{μ}_{h}}{{μ}_{e}}$$

where the quotient

$$\frac{{μ}_{h}}{{μ}_{e}}$$

may also be a number calculated phenomenologically.
d. Calculation of the quantity Q_{h,d}ⁱ·gₑ(tₑⁱ) and updating of the sum

$$S = {\sum }_{i} {Q}_{h , d}^{i} \cdot {g}_{e} ( {t}_{e}^{i} )$$

4. Upon reaching the time tₕ^{max} the quantity k is calculated:

$$\frac{1}{k} = \frac{S}{{Q}_{h , d}^{total}} = {\sum }_{i} \frac{{Q}_{h , d}^{i}}{{Q}_{h , d}^{total}} \cdot {g}_{e} ( {t}_{e}^{i} )$$

5. Correction of the electron signal Q_{e,d}^{total} according to Q_{e,d}^{total}=k·Q_{e,m}^{total}
6. Output of this number. Clearing of all memories and resetting of the clock to zero. The clock is then restarted.

According to a further advantageous embodiment of the invention, the approximation

Q_{h,d}^{total}≈Q_{e,m}^{total}

is used. As the losses for the holes are significantly greater than for the electrons, Q_{e,m}^{total} is regarded as a good estimate for Q_{h,d}^{total}. The advantage of this approximation is that even for short hole lifetimes it provides an estimated value, even though possibly no holes can be detected on the cathode side. This applies in particular to holes that have arisen close to the anode side. A further advantage is the possibility of interrupting the measurement after starting the clock and before time tₕ^{max} is reached, and settling for a partial correction. This approach may be advantageous in the case of high event rates.

In the following, Q_{e/h,m/d}^{i,rest} denote the quantities:

$${Q}_{e / h , m / d}^{total} - {\sum }_{j = 1}^{i} {Q}_{e / h , m / d}^{j}$$

Then:

$${Q}_{e , m}^{total} = ( {Q}_{e , d}^{total} - {Q}_{e , d}^{i , rest} ) \cdot {\sum }_{j = 1}^{i} \frac{{Q}_{h , d}^{j}}{{Q}_{h , d}^{total}} \cdot {g}_{e} ( {t}_{e}^{j} ) + {Q}_{e , m}^{i , rest}$$

From

Q_{e,d}^{total}−Q_{e,d}^{i,total}=Q_{h,d}^{total}−Q_{h,d}^{i,rest}

it follows that:

$${Q}_{e , m}^{total} = ( {Q}_{h , d}^{total} - {Q}_{h , d}^{i , rest} ) \cdot ( {\sum }_{j = 1}^{i} \frac{{Q}_{h , d}^{j}}{{Q}_{e , m}^{total}} \cdot {g}_{e} ( {t}_{e}^{j} ) - 1 ) + {Q}_{e , d}^{total}$$

From this, it follows that:

$${Q}_{e , d}^{total} = {Q}_{e , m}^{total} + ( {\sum }_{j = 1}^{i} {Q}_{h , d}^{j} ) \cdot ( 1 - {\sum }_{j = 1}^{i} \frac{{Q}_{h , d}^{j}}{{Q}_{e , m}^{total}} \cdot {g}_{e} ( {t}_{e}^{j} ) )$$

$${Q}_{e , d}^{total} = {Q}_{e , m}^{total} + ( {\sum }_{j = 1}^{i} {Q}_{h , m}^{j} \cdot {f}_{h} ( {t}_{h}^{j} ) ) \cdot ( 1 - {\sum }_{j = 1}^{i} \frac{{Q}_{h , m}^{j} \cdot {f}_{h} ( {t}_{h}^{j} )}{{Q}_{e , m}^{total}} \cdot {g}_{e} ( {t}_{e}^{j} ) )$$

According to a further advantageous embodiment of the invention, the following approximation is used:

Q_{e,m}^{i,rest}≈Q_{e,d}^{i,rest}

In the following, Q_{i/h,m/d}^{i,rest} as stated above denote the quantities

$${Q}_{e / h , m / d}^{total} - {\sum }_{j = 1}^{i} {Q}_{e / h , m / d}^{j} .$$

This means that in the event of incomplete detection of all charge carriers of the i^{th} electron-hole pair cloud generated in the detector body by the ionising radiation, the remainder from the charge measured on the cathode side is a good estimate of the deposited residual charge. This remainder will prove to be the non-correctable portion in the following:

For Q_{e,m}^{i,rest} it applies that:

$${Q}_{e , m}^{i , rest} = {Q}_{e , m}^{total} - {\sum }_{j = 1}^{i} {Q}_{e , m}^{j} = {Q}_{e , m}^{total} - {\sum }_{j = 1}^{i} {Q}_{e , d}^{j} \cdot {g}_{e} ( {t}_{e}^{j} )$$

$${Q}_{e , d}^{i , rest} = {Q}_{e , m}^{total} - {\sum }_{j = 1}^{i} {Q}_{e , d}^{j} \cdot {g}_{e} ( {t}_{e}^{j} ) \vert + {\sum }_{j = 1}^{i} {Q}_{e , d}^{j}$$

$$\begin{matrix}{Q}_{e , d}^{i , rest} + {\sum }_{j = 1}^{i} {Q}_{e , d}^{j} = {Q}_{e , m}^{total} + {\sum }_{j = 1}^{i} {Q}_{e , d}^{j} ( 1 - {g}_{e} ( {t}_{e}^{j} ) ) = \\ = {Q}_{e , m}^{total} + {\sum }_{j = 1}^{i} {Q}_{h , m}^{j} \cdot {f}_{h} ( {t}_{h}^{i} ) \cdot ( 1 - {g}_{e} ( {t}_{e}^{j} ) )\end{matrix}$$

It follows from

$${Q}_{e , d}^{i , rest} + {\sum }_{j = 1}^{i} {Q}_{e , d}^{j} = {Q}_{e , d}^{total}$$

that:

$${Q}_{e , d}^{total} = {Q}_{e , m}^{total} + {\sum }_{j = 1}^{i} {Q}_{h , m}^{j} \cdot {f}_{h} ( {t}_{h}^{j} ) ( 1 - {g}_{e} ( {t}_{e}^{j} ) )$$

where the following applies for tₑ^{j} as above:

$${t}_{e}^{j} = ( {t}_{h}^{max} - {t}_{h}^{j} ) \cdot \frac{{μ}_{h}}{{μ}_{e}}$$

The definition:

h(tₕ^{j}):=fₕ(tₕ^{j})·(1−gₑ(tₑ^{j}))

means:

$${Q}_{e , d}^{total} = {Q}_{e , m}^{total} + {\sum }_{j = 1}^{i} {Q}_{h , m}^{j} \cdot h ( {t}_{h}^{j} )$$

The above approximation offers scope for combining with the relative gain method. To that end the functions f and g must be adapted to the method. Electron-hole pair clouds that have arisen close to the anode side can thus be corrected even if possibly no holes can be detected on the cathode side. Furthermore, in the case of high event rates a shorter measuring time can be used and the correction thus applied only for partial incidents that have occurred far from the anodes. The transit time of the holes to these electron-hole pairs is relatively short.

Further advantages and advantageous configurations of the invention can be obtained from the following description, the drawing and the claims.

### DRAWING

The signals for the electrodes on the anode side and cathode side are shown in the drawing for a detector according to the invention. Illustrations:

FIG. 1 Perspective view of a detector,

FIG. 2 Top view of the anode side of the detector as shown in FIG. 1,

FIG. 3 Top view of the cathode side of the detector as shown in FIG. 1,

FIG. 4 Circuit diagram of a detector as shown in FIG. 1 with high-voltage power supply and a charge-sensitive pre-amplifier,

FIG. 5 Representation of the signals for the electrodes on the anode side and their difference in a specimen event from two Compton scatterings followed by photoabsorption,

FIG. 6 Representation of the signals for the electrodes on the cathode side and their difference for the same event as in FIG. 4 from two Compton scatterings followed by photoabsorption.

### DESCRIPTION OF THE MODEL EMBODIMENT

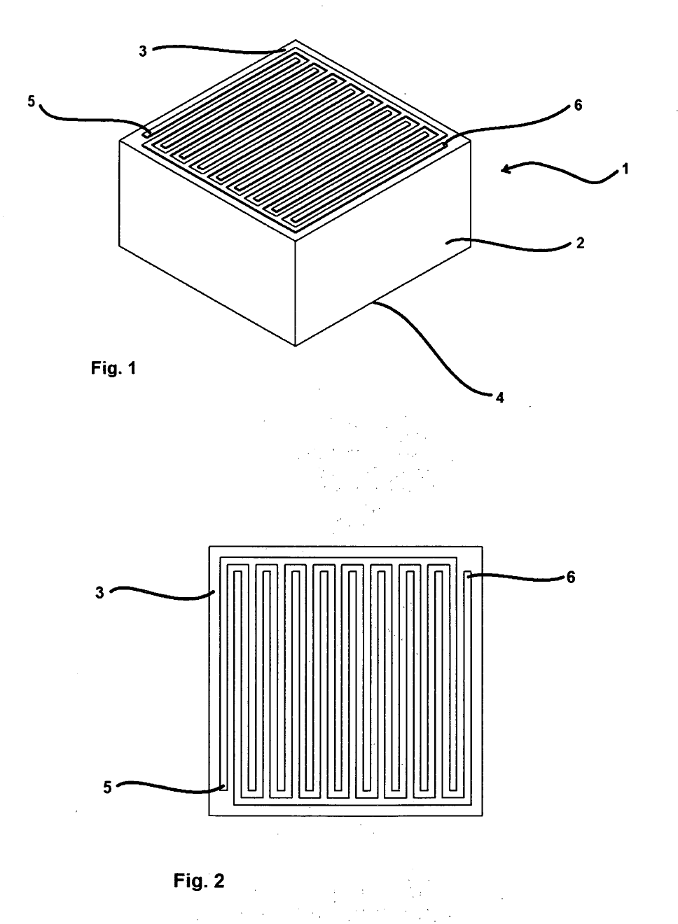

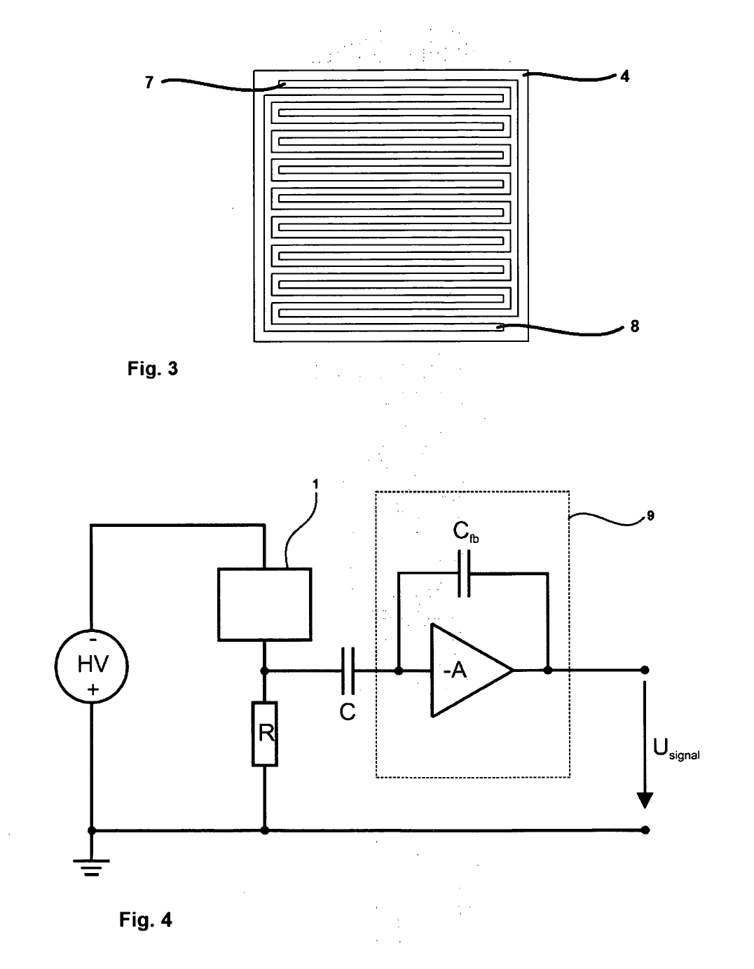

FIGS. 1 to 3 show a cuboid-shaped detector 1 with a detector body 2 made from a semiconductor material. One of the sides of the detector 1 takes the form of the anode side 3. The side opposite the anode side takes the form of the cathode side 4. Both the anode side 3 and the cathode side 4 are each equipped with two electrodes. The two electrodes 5 and 6 on the anode side 3 exhibit a comb-shaped structure with several parallel elongated sections. The sections take the form of strips. The elongated sections of the two electrodes 5 and 6 mesh in such a way that the elongated sections of the first electrode 5 alternate with the elongated sections of the second electrode 6. The two electrodes 5 and 6 do not make contact with each other. The distance between the individual sections of the first electrode 5 and the second electrode 6 is essentially the same throughout.

The two electrodes 7 and 8 on the cathode side essentially have the same form as the two electrodes 5 and 6 on the anode side.

The two electrodes 5, 6 in coplanar arrangement on the anode side 3 form a coplanar grid for electrons. The two electrodes 7, 8 in coplanar arrangement on the cathode side 4 form a coplanar grid for holes.

FIG. 4 shows a principle for a circuit diagram of a detector 1 as shown in FIG. 1. As well as the detector 1, the circuit shows a high-voltage source HV, a charge-sensitive pre-amplifier 9, a bias resistor R and a capacity C for AC coupling. The charge-sensitive pre-amplifier 9 is equipped with an inverting amplifier with amplification −A and with a feedback capacity C_{fb}. To maintain a constant potential difference between the detector's electrodes with drifting electrodes and holes in the detector body, charge flows from the feedback capacity C_{fb} to the detector's electrodes. This leads to a change in the potential difference of the feedback capacitor with the feedback capacity C_{fb}. This change in the potential difference is amplified and detected as signal U_{signal}. The circuit diagram shows the principle of a detector circuit for one electrode on the anode side and one electrode on the cathode side. Since both the anode side and the cathode side are each equipped with two electrodes in the detector according to FIG. 1, there are circuits with four charge-sensitive pre-amplifiers to detect the signals for the four electrodes in total. Of these four pre-amplifiers, only one is shown in the drawing. In addition, a subtractor not shown in the drawing is provided to calculate the difference between the signals of the two electrodes on the cathode side and the difference between the two electrodes on the anode side.

The electrodes 5, 6 on the anode side 3 and the electrodes 7, 8 on the cathode side each exhibit a defined potential, these potentials being different. A potential difference is generated between the electrodes 5, 6, 7, 8 via the circuits and the voltage source. The potential difference between the two electrodes 5 and 6 on the anode side 3 is small compared with the potential difference between each of the two electrodes 5, 6 on the anode side on the one hand and each of the two electrodes 7, 8 on the cathode side 4 on the other hand. Furthermore, the potential difference between the two electrodes 7, 8 on the cathode side 4 is small compared with the potential difference between each of the two electrodes 7, 8 on the cathode side 4 on the one hand and each of the two electrodes 5, 6 on the anode side on the other hand.

Incident ionising radiation, for example gamma, radiation, generates electron-hole pairs in the detector body 2. These move in the electric field generated between the electrodes by the potential difference. The electrons migrate to the anode side 3 and the holes to the cathode side 4.

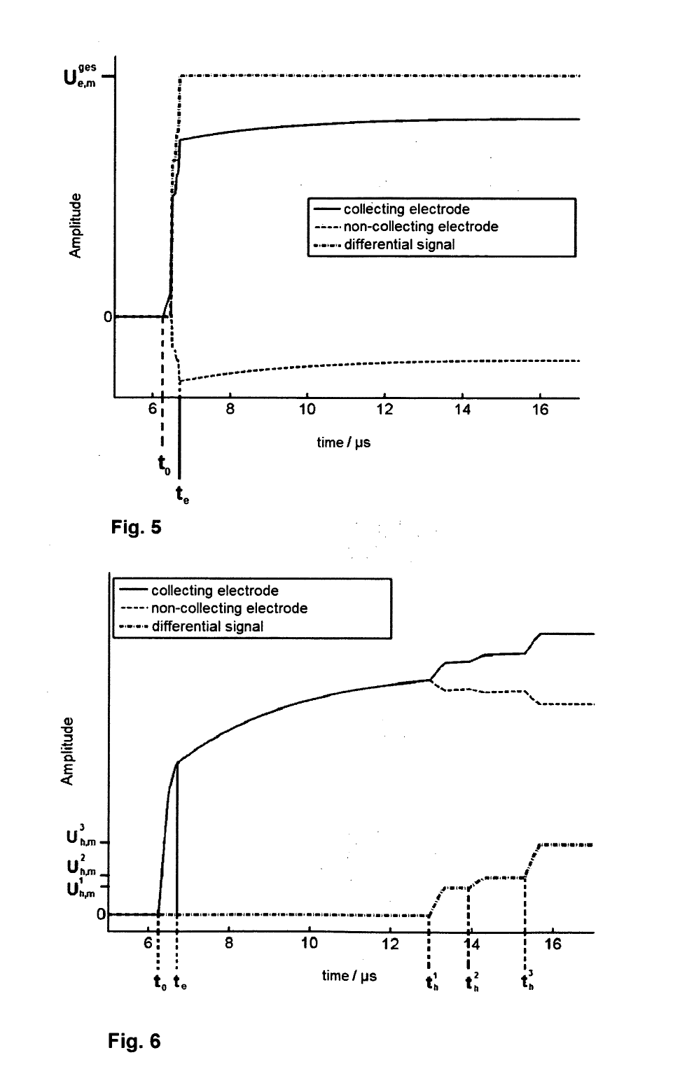

FIGS. 5 and 6 show the signals for electrodes 5, 6, 7, 8 of detector 1. The progress in time of the change in the potential difference of the feedback capacity C_{fb} corresponds to the signal. All electrodes have a different potential. The electrode on the anode side with the greater potential difference compared with the electrodes on the cathode side is referred to as the anode side's collecting electrode. The electrode on the anode side with the smaller potential difference compared with the cathode side is referred to as the anode side's non-collecting electrode. The electrode on the cathode side with the greater potential difference compared with the electrodes on the anode side is referred to as the cathode side's collecting electrode. The electrode on the cathode side with the smaller potential difference compared with the anode side is referred to as the cathode side's non-collecting electrode.

The detector body is exposed to an ionising radiation that generates electron-hole pairs in the detector body. In the electric field of the detector body, the electrons migrate to the anode side and the holes to the cathode side. Compton scattering occurs, with the result that the electrons and the holes of the various occurrences reach the electrodes on the anode side and cathode side at different times.

The signals for the collecting and the non-collecting electrode on the anode side as well as the difference between them is shown in FIG. 5. The signal for both electrodes initially rises gently upon formation of the electron-hole pairs, then steeply. The steps in the steep rise indicate Compton scattering. When all electrons formed have reached the anode side by point in time tₑ, the signal for the electrodes then rises only very slightly. This slight rise is caused by the holes of the electron-hole pairs drifting to the cathode side. The formation of the difference between the two signals eliminates the slight rises and amplifies the steep rise. The differential signal is constant apart from the steep rise. Q_{e,m}^{total} and t₀ can be determined from the differential signal. Because the charge is proportional to the voltage, U_{e,m}^{total} directly provides Q_{e,m}^{total}.

The progress in time of the signals for the collecting and the non-collecting electrode on the cathode side as well as the difference between them is shown in FIG. 6. The signals for both electrodes exhibit a steep rise in the range between 6 μs and 7 μs. The electrons of the electron-hole pairs formed by the ionising radiation are the cause. Drifting of the electrons to the electrodes on the anode side is also evident from the signal for the electrodes on the cathode side. It is therefore also possible to determine t₀ from the signals for FIG. 6. The point in time tₑ is also identifiable in FIG. 6. At around 13 μs there is an initial steep rise in the signal for the collecting electrode. This is caused by the first holes of the electron-hole pairs generated reaching the cathode side. These originate from an initial Compton scattering event resulting in electron-hole pairs being formed particularly close to the cathode side. The rise is even clearer in the difference between the two signals for the collecting and the non-collecting electrode. The time tₕ¹ can be determined from this initial rise. At approx. 14 μs there is a second rise in the signal for the collecting electrode and in the differential signal. A second Compton scattering event is the cause. tₕ² can be determined from this. At approx. 15.5 μs a third rise in the signal can be identified. It indicates a third event. tₕ³ can be determined from this. From the values for the difference in the signals for the collecting and the non-collecting electrode in the range of the three rises in the signal, it is possible to determine

U_{h,m}¹,U_{h,m}² and U_{h,m}³

and, based on the proportionality between U and Q

Q_{h,m}¹,Q_{h,m}² and Q_{h,m}³

can also be determined.

From the values determined using the signals according to FIGS. 5 and 6, Q_{e,d}^{total} can be calculated using the approximations described above and the values determined by calibration measurements.

All features of the invention can be material to the invention both individually and in any combination.

### REFERENCE NUMBERS

1 Detector
2 Detector body
3 Anode side
4 Cathode side
5 Electrode of the anode side
6 Electrode of the anode side
7 Electrode of the cathode side
8 Electrode of the cathode side
9 Charge-sensitive pre-amplifier

1. Detector for the detection of ionizing radiation
with a detector body (2) made from a semiconductor material in which incident ionizing radiation generates free electron-hole pairs,
with a cathode side (4) of the detector body (2) to which the free holes generated drift in an electric field,
with an anode side (3) of the detector body (2) to which the free electrons generated drift in an electric field,
with at least two electrodes (5, 6) on the anode side (3),
with at least two electrodes (7, 8) on the cathode side (4),
with several sections of a first electrode (7) on the cathode side (4) and several sections of a second electrode (8) on the cathode side (4), where the sections of the first and the second electrode (7, 8) are arranged next to each other on the cathode side (4) and extend in an alternating structure essentially across the entire cathode side (4),
with a potential difference between the electrodes (7, 8) on the cathode side (4) and with a potential difference between each of the electrodes (7, 8) on the cathode side (4) on the one hand and each of the electrodes (5, 6) on the anode side (3) on the other hand, where the potential difference between the electrodes (7, 8) on the cathode side (4) is smaller than the potential difference between each of the electrodes (5, 6) on the anode side (3) on the one hand and each of the electrodes (7, 8) on the cathode side (4) on the other hand.

2. Detector according to claim 1, wherein the electrodes (7, 8) on the cathode side (4) are in a coplanar arrangement.

3. Detector according to claim 1, wherein the sections of the first and the second electrode (7, 8) on the cathode side (4) interlock with each other and wherein in each case a section of the first electrode (7) is adjacent to at least one section of the second electrode (8) and vice-versa.

4. Detector according to claim 1, wherein at least some of the sections of the first electrode (7) on the cathode side (4) take the form of strips, and wherein at least some of the sections of the second electrode (8) on the cathode side (4) take the form of strips.

5. Detector according to claim 4, wherein the strips exhibit a rectilinear shape and are parallel with each other.

6. Detector according to claim 4, wherein the strips exhibit a curved shape around a common center.

7. Detector according to claim 1, wherein the electrodes (5, 6) on the anode side (3) form a coplanar grid.

8. Detector according to claim 1, wherein the electrodes (5, 6) on the anode side (3) form a two-dimensional pixel array.

9. Method for the detection of ionizing radiation with a detector according to claim 1, comprising the following process steps:
Application of a voltage to the electrodes (5, 6) on the anode side (3) and the cathode side (4), where the potential difference between the electrodes (5, 6) on the anode side (3) on the one hand and the electrodes (7, 8) on the cathode side (4) on the other hand is greater than the potential difference between the individual electrodes (7, 8) on the cathode side (4),
Generation of electron-hole pairs in the detector (1) by irradiation of the detector body (2) with ionizing radiation,
Detection of an initial signal for a first electrode (7) on the cathode side (4),
Detection of a second signal for a second electrode (8) on the cathode side (4),
Calculation of the difference between the first and the second signal,
Determination of the transit times of the holes between the position where the electron-hole pairs have arisen and the electrodes (7, 8) on the cathode side (4) from the difference.

10. Method according to claim 9, wherein the transit times of the holes are used to determine the distance between the position of formation of corresponding electron-hole pairs in the detector body (2) and the anode side (3) or the cathode side (4).

11. Method according to claim 9, wherein a signal for one or more electrodes (5, 6) on the anode side (3) is detected, and wherein the signal is corrected by means of the transit times of the holes and/or the position of formation of the electron-hole pairs.

12. Method according to claim 11, wherein the detector (1) is equipped with a collecting and a non-collecting electrode (5, 6) on the anode side (3) forming a coplanar grid, wherein the total charge Q_{e,m}^{total} of the electrons arriving at the anode side (3) of the electron-hole pairs formed by the incident radiation is determined by the difference between the signal for the collecting electrode (5) and the non-collecting electrode (6), wherein the charge Q_{h,m}ⁱ of the holes of the i^{th} electron-hole pair cloud and the transit time tₕⁱ of the holes of the i^{th} electron-hole pair cloud is determined by the difference between the first and the second signal for the electrodes (7, 8) on the cathode side (4), and wherein the total charge Q_{e,d}^{total} of all electrons for the electron-hole pairs formed by the incident radiation is calculated from the product of Q_{e,m}^{total} and the factor k, where k depends on the total of all Q_{h,m}ⁱ, the transit times tₕⁱ of the holes, the mobility of the electrons and holes in the detector body, the potential difference between the electrodes (5, 6, 7, 8) and the distance between the anode side (3) and the cathode side (4).

13. Method according to claim 12, wherein k is calculated with
1/k=ΣQ_{h,d}ⁱ/Q_{h,d}^{total}*gₑ(tₑⁱ)
where Q_{h,d}ⁱ is the charge of all holes of the i^{th} electron-hole pair cloud formed by the radiation, Q_{h,d}^{total} is the total charge of all holes of the electron-hole pairs formed by the incident radiation, tₑⁱ is the transit time of the electrons of the i^{th} electron-hole pair cloud, and wherein gₑ(tₑⁱ) is determined by calibration measurements at the detector.

14. Method according to claim 12, wherein k is calculated with
1/k=ΣQ_{h,d}ⁱ/Q_{h,d}^{total}*gₑ(tₑⁱ)
where Q_{h,d}ⁱ is the charge of all holes of the i^{th} electron-hole pair cloud formed by the incident radiation, Q_{h,d}^{total} is the total charge of all holes of the electron-hole pairs formed by the incident radiation, tₑⁱ is the transit time of the electrons of the i^{th} electron-hole pair cloud, and wherein gₑ(tₑⁱ) in the first approximation is given as gₑ(tₑⁱ)==exp(−tₑⁱ/Tₑ), where Tₑ is the lifetime of the electrons.

15. Method according to claim 14, wherein the lifetime Tₑ of the electrons is determined experimentally.

16. Method according to claim 12, wherein the approximation Q_{h,d}^{total}≈Q_{e,m}^{total} is used.
